(19) United States
(12) Patent Application Publication
(10) Pub. No.: US 2016/0156714 A1
(43) Pub. Date: Jun. 2, 2016

(54) CONTENT PLACEMENT IN AN INFORMATION CENTRIC NETWORK

(71) Applicant: FUJITSU LIMITED, Kawasaki-shi (JP)

(72) Inventors: Golnaz FARHADI, Sunnyvale, CA (US); Bita AZIMDOOST, Los Gatos, CA (US)

(21) Appl. No.: 14/557,272

(22) Filed: Dec. 1, 2014

(51) Int. Cl. H04L 29/08

(52) U.S. Cl. CPC H04L 67/1097; H04L 67/2842

(57) ABSTRACT

A method includes receiving an interest packet that originated from a request node, wherein a decision maker node and the request node are part of a plurality of nodes of a sub-network with a tree topology and wherein the interest packet identifies a content and the request node. In response to the content being stored in one or more intermediate nodes of the plurality of nodes, the method also includes: receiving the interest packet with a satisfied flag on at the decision maker node; and updating an access history table at the decision maker node. In response to the content being absent from each of the one or more intermediate nodes, the method also includes: receiving the interest packet with the satisfied flag off at the decision maker node; updating the access history table at the decision maker node; and checking the decision maker node for the content.

### FIELD

The implementations discussed herein are related to content placement in an information centric network.

### BACKGROUND

Unless otherwise indicated herein, the materials described herein are not prior art to the claims in the present application and are not admitted to be prior art by inclusion in this section.

While present Internet structures are host-oriented and configured based on a one-to-one paradigm, a majority of current Internet uses, such as viewing and sharing videos, music, photographs, documents, and more, may have a data or content centric aspect different from a host centric aspect. Information centric networks (ICNs), in which endpoints communicate based on named data instead of Internet Protocol (IP) addresses, have evolved as an alternative to the host-oriented Internet architecture. ICNs seek to provide scalable and cost-efficient content distribution.

The subject matter claimed herein is not limited to implementations that solve any disadvantages or that operate only in environments such as those described above. Rather, this background is only provided to illustrate one example technology area where some implementations described herein may be practiced.

### SUMMARY

According to an aspect of an implementation, a method includes receiving, at a decision maker node, an interest packet that originated from a request node, wherein the decision maker node and the request node are part of a plurality of nodes of the sub-network with a tree topology and wherein the interest packet identifies a content and the request node. The method also includes, in response to the content being stored in one or more intermediate nodes of the plurality of nodes of the sub-network, wherein the one or more intermediate nodes are located in a path between the request node and the decision maker node: receiving the interest packet with a satisfied flag on at the decision maker node; and updating an access history table at the decision maker node. The method also includes, in response to the content being absent from each of the one or more intermediate nodes of the plurality of nodes of the sub-network: receiving the interest packet with the satisfied flag off at the decision maker node; updating the access history table at the decision maker node; and checking the decision maker node for the content.

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Example implementations will be described and explained with additional specificity and detail through the use of the accompanying drawings in which:

FIG. 1 is a schematic diagram illustrating an example ICN in which some implementations may be implemented;

FIG. 2A is a schematic diagram of three example data structures of a typical ICN router;

FIG. 2B is a schematic diagram of an example solution table and access history table at a decision maker router;

FIG. 3A is a schematic diagram illustrating an example ICN that includes a sub-network with a two-level tree topology;

FIGS. 3B-3C illustrate an example linear program optimization that may be executed by a decision maker node;

FIG. 3D is a table of notations used in the linear program optimization of FIGS. 3B-3C;

FIG. 4 is a block diagram illustrating an example ICN router system;

FIGS. 5A-5C are schematic diagrams of example content retrieval scenarios; and

FIG. 6 is an example flow diagram illustrating a content placement scheme among a network of nodes in a sub-network of an ICN.

### DESCRIPTION OF IMPLEMENTATIONS

The demand for streaming video and audio on the Internet has grown in recent years, increasing Internet traffic. Information Centric Networks (ICNs) provide an architecture for in-network caching to enhance content delivery. An ICN may include one or more sub-networks, in which routers may be connected to one another to share content. Each router of the one or more sub-networks may also have storage space to store requested content. In a sub-network of an ICN, when the total storage and link capacities are limited, optimization of both the location at which content is stored and the storage size allocation at each router may reduce the overall cost of data delivery for the ICN. Accordingly, some implementations described herein relate to an ICN architecture and supporting communication protocols capable of reducing the total cost of data delivery to the network or content provider through optimization. “Optimization” as referred to herein may include maximizing or minimizing a real function, where “maximizing” or “minimizing” does not necessarily mean achieving an absolute maximum or minimum but a relative maximum or minimum as compared with other values.

In some implementations described herein, a scalable, linear program optimization based on the popularity of requested contents at each node in a sub-network may be executed or solved to determine content placement and storage size allocation in the sub-network.

Implementations of the present invention will be explained with reference to the accompanying drawings.

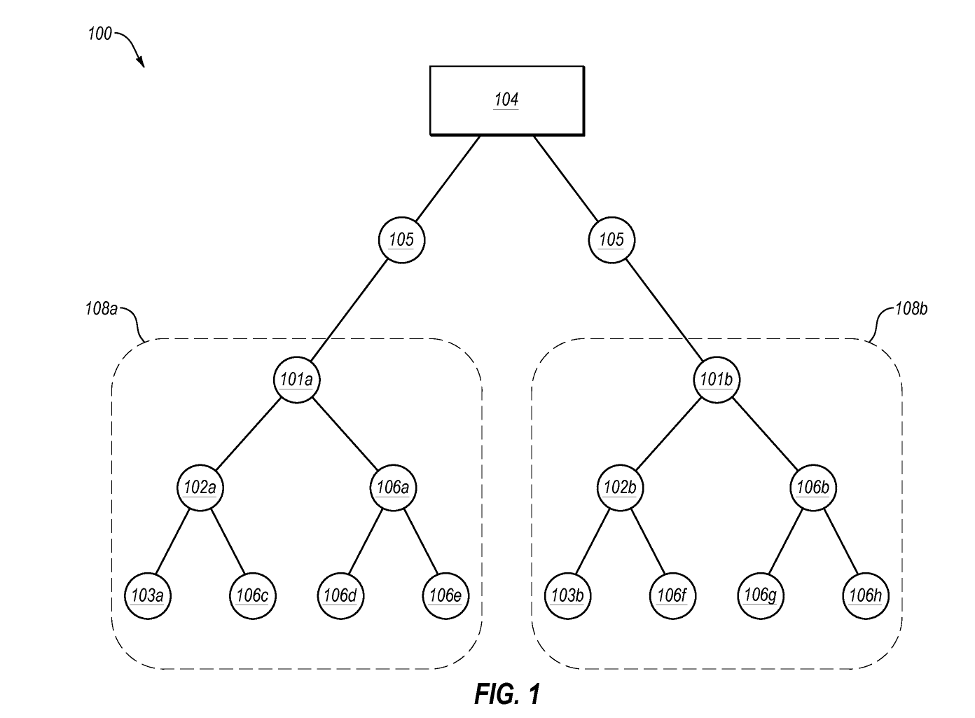

FIG. 1A is a schematic diagram of an example ICN 100, arranged in accordance with at least one implementation described herein. The ICN 100 may include a network of nodes configured to route messages, which may also be referred to as “interest packets,” and to deliver data packets. The term “interest packet” may refer to a request for some content. The term “data packet” may refer to the content that satisfies the interest packet. Each interest packet may correspond to one data packet.

In various implementations, the ICN 100 may include or may be included in the Internet or a portion thereof. As illustrated in FIG. 1A, the ICN 100 may include a server 104 and a number of network nodes, including two upstream nodes 105, two core or decision maker nodes 101a, 101b (generically “decision maker node 101” or “decision maker nodes 101”), two intermediate nodes 102a,102b (generically “intermediate node 102” or “intermediate nodes 102”), two request nodes 103a-103b (generically “request node 103” or “request nodes 103”), and eight peer nodes 106a-106h (generically “peer node 106” or peer nodes 106″).

It will be appreciated, with the benefit of the present disclosure, that the ICN 100 illustrated in FIG. 1A may constitute, in some respects, a simplification. For example, the ICN 100 may include different numbers of the request nodes 103, intermediate nodes 102, peer nodes 106, and/or decision maker nodes 101 than are illustrated in FIG. 1A. The ICN 100 may include additional upstream nodes 105 between the decision maker nodes 101 and the server 104. The ICN 100 may include additional intermediate nodes 102 between decision maker node 101 and request nodes 103. The ICN 100 may include numerous additional network nodes, such as clients, servers, routers, switches, and/or other network devices. Further, decision maker nodes 101 may be directly coupled to the request nodes 103. The decision maker nodes 101 may be directly coupled to the server 104. The request nodes 103 may be directly coupled to the decision maker node 101.

The network topology of the ICN 100 may include a hierarchical structure. The network topology may include a tree structure or set of tree structures. In the hierarchical tree structure topology shown in FIG. 1A, the intermediate nodes 102 may interconnect the decision maker nodes 101 and the request nodes 103, such that interest packets and data packets may be exchanged between these nodes. The decision maker nodes 101 may interconnect the intermediate nodes 102 and the upstream nodes 105 on the path to the server 104, such that interest and data packets may be exchanged between these nodes. Similarly, the upstream nodes 105 may interconnect the decision maker nodes 101 and the server 104, such that interest and data packets may be exchanged between these nodes. The request nodes 103 and the peer nodes 106 may be considered to be downstream from the intermediate nodes 102, which may be considered to be downstream from the decision maker nodes 101, which may be considered to be downstream from the upstream nodes 105, which may be considered to be downstream from the server 104.

Each of the request nodes 103, peer nodes 106, intermediate nodes 102, decision maker nodes 101, and upstream nodes 105 of the network may include a router. The term “router” may refer to any network device capable of receiving and forwarding interest packets and/or receiving and forwarding data packets. The term “server” may refer to any device capable of receiving interest packets and serving data packets. The request nodes 103, peer nodes 106, intermediate nodes 102, decision maker nodes 101, upstream nodes 105, and server 104 may host a content, or more generally one or more different contents, each content being identified by at least one content name.

Each of the request nodes 103 may include or may be coupled to a client device, such as a desktop computer, a laptop computer, a tablet computer, a mobile phone, a smartphone, a personal digital assistant (PDA), a wearable device, or other client device.

The ICN 100 may include one or more sub-networks 108a, 108b (generically “sub-network 108” or “sub-networks 108”). Each sub-network may include one decision maker node 101. A node that is downstream from a decision maker node 101 in a sub-network 108 and from which a request for a content originates is referred to herein as a “request node.” When an interest packet originates from a request node 103 in the sub-network 108, the interest packet may then be routed to the decision maker node 101 of the sub-network 108 and may be received by the decision maker node 101, even if the interest packet has already been satisfied by delivery of the corresponding data packet from an intermediate node 102 in the sub-network 108. The interest packet may identify the requested content name, the request node 103, and any nodes that forward the interest packet to the decision maker node 101. The decision maker node 101 may thus act as a data collector for the sub-network 108, keeping track of how many times a content has been accessed by each node in the sub-network 108 in an access history table. The decision maker node 101 may use the access history table to determine the popularity of the content at each node in the sub-network 108.

The decision maker node 101 may execute a linear program optimization, including a parameter based on the popularity of each content of the sub-network 108 at each node in the sub-network 108, to determine how to allocate storage size at one or more nodes of the sub-network 108 and where to place each of the contents in the sub-network 108 to minimize the total cost of data download in the sub-network 108. Based on a solution of the linear program optimization, the decision maker node 101 may set one or more cache flags in the data packet of a content to inform one or more nodes in the sub-network 108 to store the content. Thus, contents requested in a sub-network 108 may be placed in-network and storage size may be allocated to provide more cost-efficient delivery of the contents to request nodes 101 in the sub-network 108.

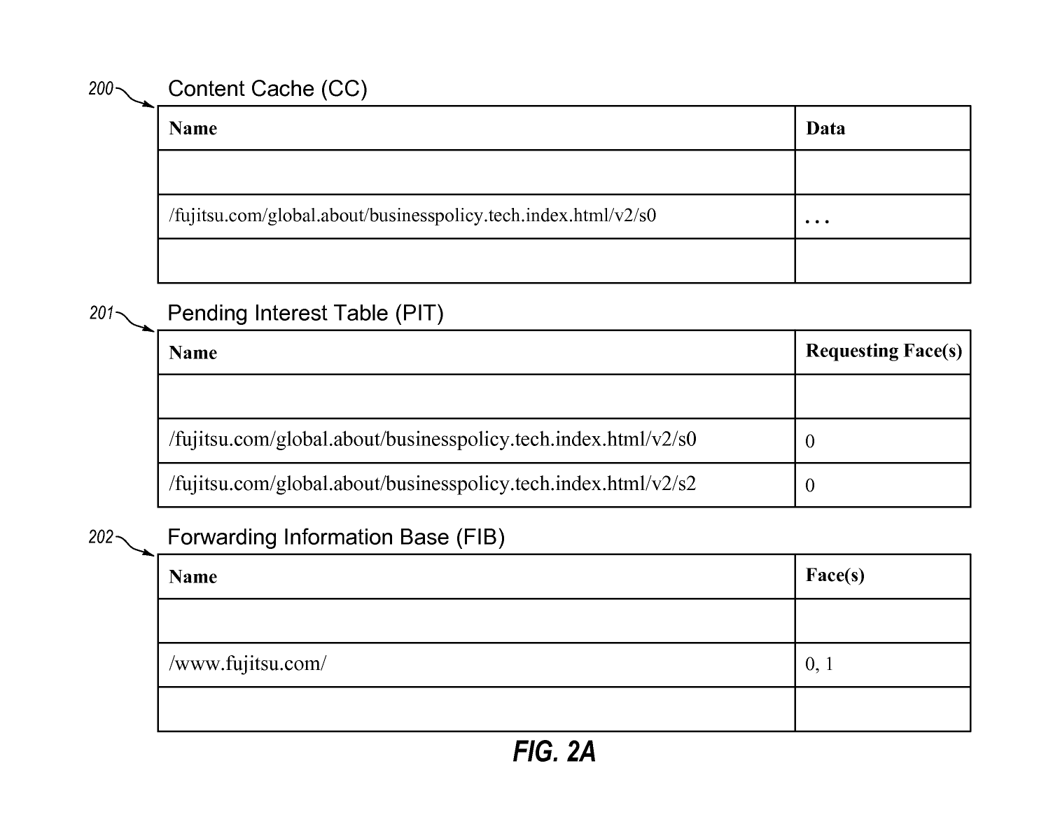

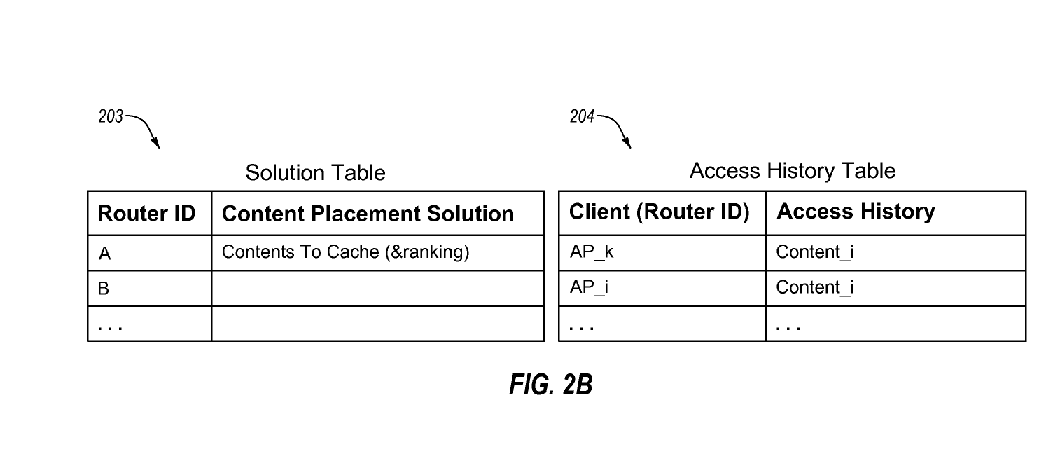

To implement the foregoing, each of the request nodes 103, peer nodes 106, intermediate nodes 102, and decision maker nodes 101 of the ICN 100 may include a router with a pending interest table (PIT), a forwarding information base (FIB), and a content cache (CC) to perform forwarding, delivery, and storage tasks, including recording of interest packets. FIG. 2A is a schematic diagram of three example data structures of a typical ICN router, arranged in accordance with at least one implementation described herein. The three data structures include a CC 200, a PIT 201, and a FIB 202.

The CC 200 may associate interest packets with corresponding data packets. For example, the CC 200 may include a “Name” column that indicates each received interest packet and a “Data” column that indicates the corresponding data packet, which may have been received and cached at the router.

The PIT 201 may record and keep track of each received interest packet that is being served or pending (until the corresponding requested data packet is received) by associating each interest packet with one or more requesting interfaces. The requesting interfaces may be coupled to one or more request nodes 103, one or more intermediate nodes 102, and/or a decision maker node 101 via fixed (wired) links, wireless links, networks, Internet, and/or other components or systems. For example, the PIT 201 may include a “Prefix” column that indicates each interest packet and a “Requesting Face(s)” column that indicates one or more requesting interfaces, e.g. “Requesting Face 0” in FIG. 2A, for the interest packet.

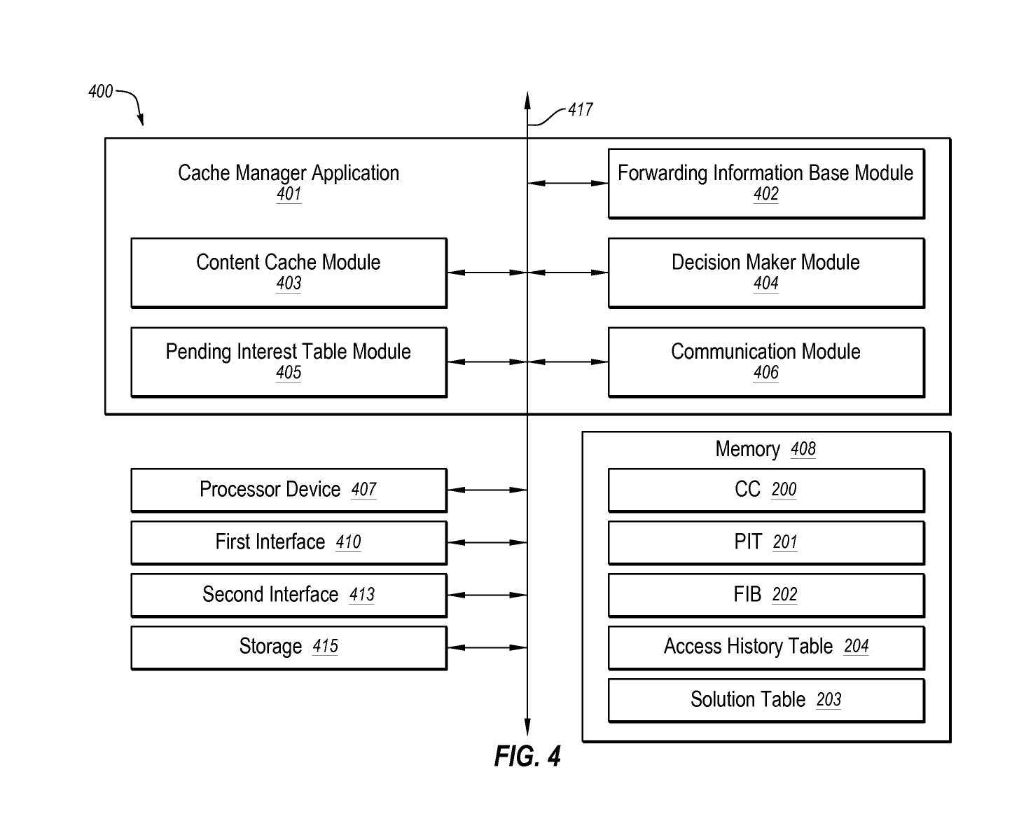

The FIB 202 may associate each interest packet with corresponding forwarding interfaces on which the interest packet may be forwarded. The forwarding interfaces may be coupled to one or more intermediate nodes 102, one or more peer nodes 106, one or more upstream nodes 105, and/or the decision maker node 101 via fixed (wired) links, wireless links, networks, Internet, and/or other components or systems. For example, the FIB 202 may include a “Name” column that indicates each interest packet and a “Face(s)” column that indicates the corresponding forwarding interfaces. A requesting interface may be referred to herein as a “first interface,” and a forwarding interface may be referred to herein as a “second interface.” The CC 200, the PIT 201, and the FIB 202 are explained in more detail with respect to FIG. 4.

In addition to the CC 200, the PIT 201, and the FIB 202, the decision maker nodes 101 of the ICN 100 may include a router with an access history table and a solution table. The access history table may be used to keep track of how many times a content has been accessed by each node in the sub-network 108. The solution table may contain the content placement solution obtained from executing the linear program optimization and may be used to keep track of where content is stored in the sub-network 108. FIG. 2B is a schematic diagram of an example solution table 203 and example access history table 204, arranged in accordance with at least one implementation described herein. The name of one or more nodes in the sub-network 108 may be entered in a row of the solution table 203 under the “Router ID” column. A list of contents to be cached at each of the routers, obtained from the linear program optimization, may be entered in the same row of the solution table 203 under the “Content Placement Solution” column. The solution table 203 may contain a Router ID for each of the routers in the sub-network. The access history table 204 may include a “Client (Router ID)” column that indicates the names of one or more routers in the sub-network 108 and an “Access History” column that indicates contents each of the one or mode routers has requested.

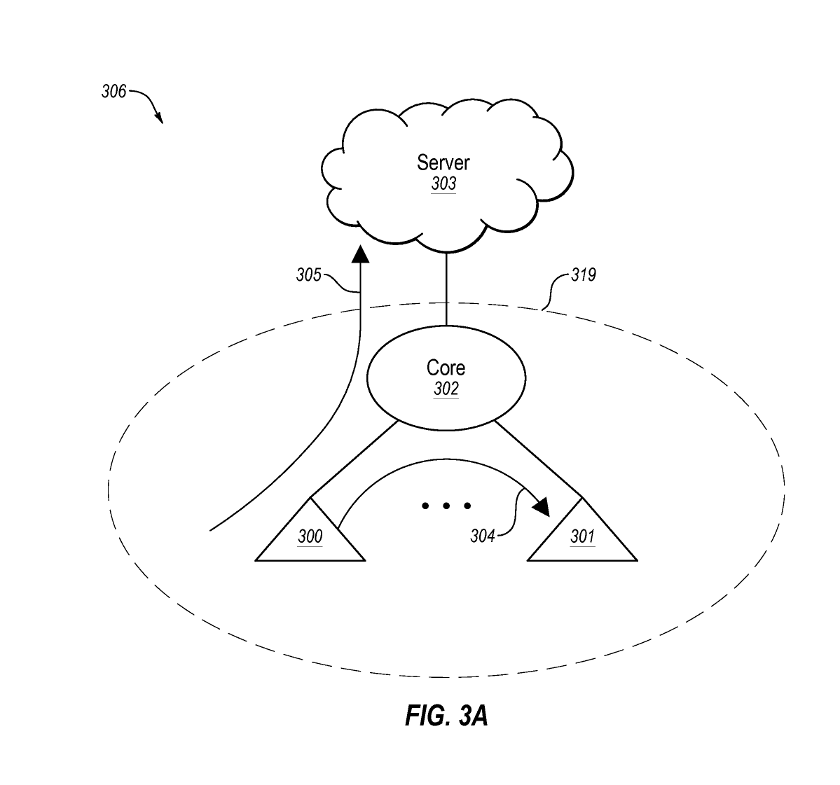

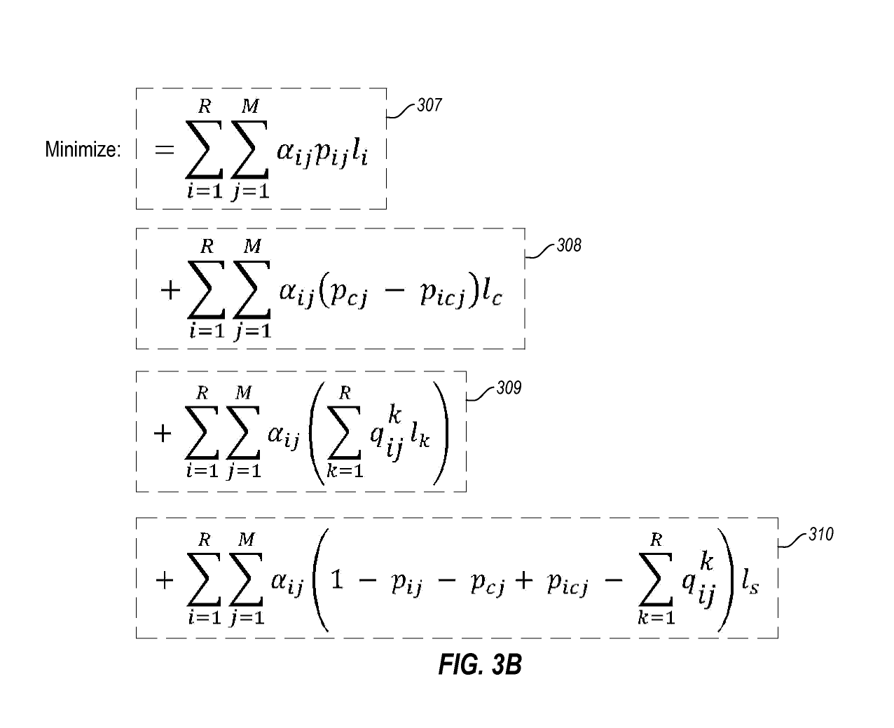

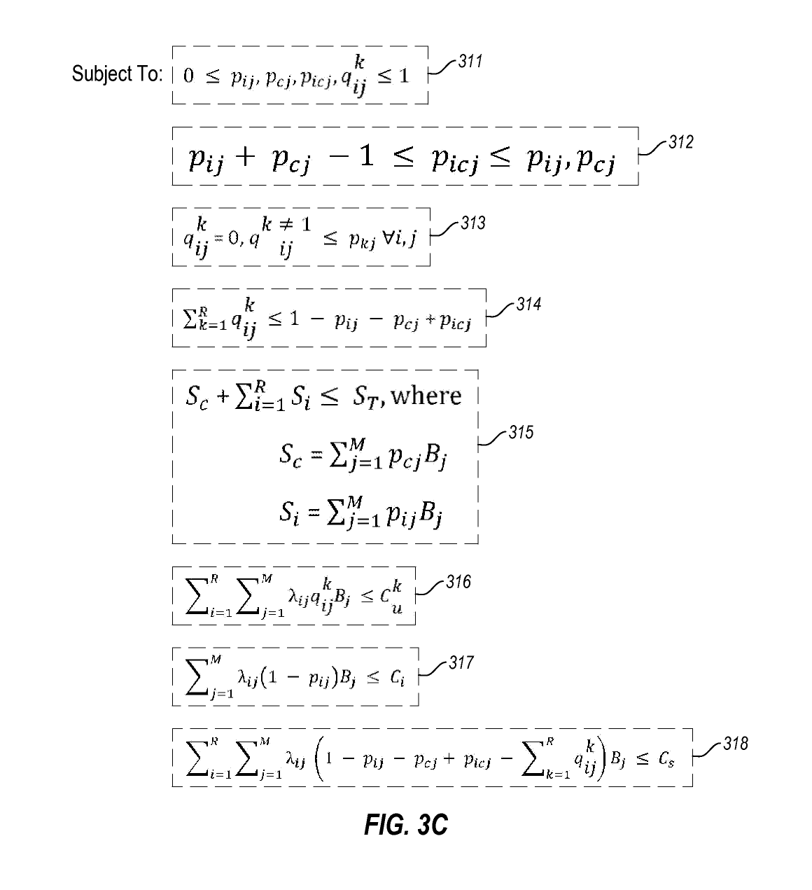

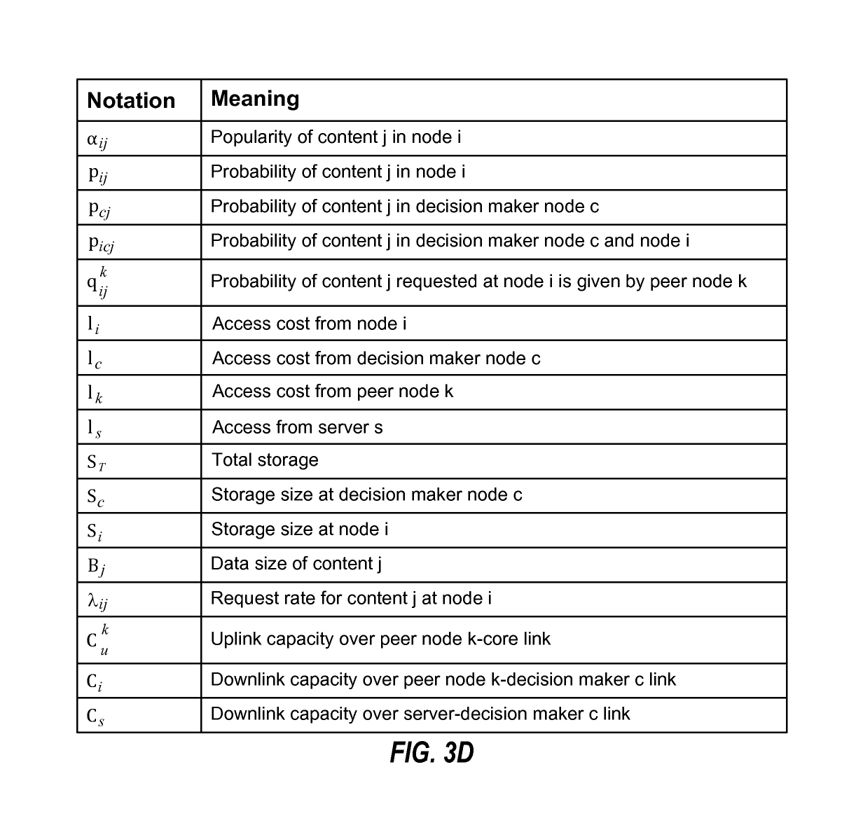

FIG. 3A is a simplified schematic diagram of an example ICN 306 that shows two levels of a sub-network 319 with a tree topology, arranged in accordance with at least one implementation described herein. As shown in FIG. 3A, a second level of the sub-network 319 may include a decision maker node 302 (“Core”), which may include or correspond to decision maker node 101 of FIG. 1.

A first level of the sub-network 319 may include one or more intermediate nodes 300 (generically referred to as “intermediate node 300” or “intermediate nodes 300”), which may include or correspond to the intermediate nodes 102 of FIG. 1. Each intermediate node 300 may be located in between a request node (not shown) and the decision maker node 302. The request node (not shown) may include or correspond to the request node 103 of FIG. 1. The first level of the sub-network 319 may also include one or more peer nodes 301 (generically “peer node 301” or “peer nodes 301”) located outside a path between the request node (not shown) and the decision maker node 302. The peer nodes 301 may include or correspond to peer nodes 106 of FIG. 1.

The ICN 306 may additionally include a server 303. The decision maker node 302 may execute a linear program optimization, an example of which is described in more detail with respect to FIGS. 3B-3D. With combined reference to FIGS. 2A-3A, in these and other implementations, if the intermediate node 300 receives an interest packet from the request node (not shown), and the corresponding data packet is absent from the CC 200 of the intermediate node 300 and the CC 200 of the decision maker node 302 but is present in the CC 200 of a peer node 301, the interest packet may be forwarded on a path 304 from the intermediate node 300 to the decision maker node 302 and then to the peer node 301. The process of forwarding an interest packet from a decision maker node to a peer node may be referred to as “nearest replica search.”

If the intermediate node 300 receives an interest packet from the request node (not shown), but the corresponding data packet is absent from the CC 200 of the intermediate node 300 and the CC 200 of the decision maker node 302, the interest packet may be forwarded on a path 305 from the intermediate node 300 to the decision maker node 302 and towards the server 303. The process of forwarding an interest packet along the path from a request node to a decision maker node may be referred to as “path search.” The linear program optimization executed by the decision maker node 302 may be compatible with both path search and nearest replica search.

FIGS. 3B-3C illustrate an example linear program optimization that may be executed by a decision maker node, arranged in accordance with at least one implementation described herein. FIG. 3D is a table of notations used in the linear program optimization of FIGS. 3B-3C, arranged in accordance with at least one implementation described herein. “Node i” referred to in FIG. 3D (and inherently by the various notations used in FIGS. 3B-3C) may include or correspond to the first-level nodes of FIG. 3A, which, as already described, may include one or more intermediate nodes 300 and/or one or more peer nodes 301. The linear program optimization of FIGS. 3B-3D will be explained in the context of FIG. 3A.

As illustrated in FIG. 3B, the objective of the linear program optimization in FIGS. 3B-3C may be to minimize total data download cost in the sub-network 319. The sub-network 319 may include or correspond to the sub-network 108 of FIG. 1. Further, the linear program optimization of FIGS. 3B-3C may be useful when total storage capacity and link capacities are limited. In FIG. 3B, the first-level nodes i may range from 1 to R and the content j requested in the sub-network 319 may range from 1 to M.

The popularity of content j in a node i may be represented by the parameter αᵢⱼ, and may be based on a ranking of content j at a node i. As the ranking of content j increases at the node i, αᵢⱼ may also increase. Ranking of content j at node i may be determined according to the demand for content j compared to other contents at node i. Demand of content j at the node i, may be estimated from past history since the decision maker node may keep track of how many times content j has been requested by each node in the sub-network 319 in an access history table. The demand may be estimated using the access history table by counting the number of times content j was requested in the past at node i. The demand may alternately or additionally be estimated by estimating the potential demand or number of times content j will be requested in the future at the node i using collaborative filtering techniques, including Singular Value Decomposition (SVD).

The access history table and demand values may be updated online with any new access request but rankings of contents at node i may be updated on, for example, a daily basis. The linear program optimization of FIGS. 3B-3C may be executed offline. In some implementations, the linear program optimization of FIGS. 3B-3C may be executed offline one time to determine storage size allocation at the nodes of the sub-network 319 when the ICN 306 is setup. When the access history table and the demand values change, the popularity parameter αᵢⱼ may be updated, but the same solution to the linear program optimization may be used but with new content ranking. A storage size allocation obtained from the linear program optimization may be relatively static and may allow a network design, including storage size at each node of the sub-network 319, to be implemented offline.

Component 307 of FIG. 3B may represent a cost of downloading a content j from the intermediate node 300 located in a path between a request node and the decision maker node 302. Component 308 may represent a cost of downloading a content j from the decision maker node 302. Component 309 may represent a cost of downloading a content j from a peer node 301. Component 310 may represent a cost of downloading a content j from the server 303.

The linear program optimization executed by the decision maker node 302 may include one or more constraints. For example, according to constraint 311 of FIG. 3C, various probabilities are constrained to values in a range from 0 to 1 inclusive. According to constraint 312 of FIG. 3C, relationships between some of the probabilities are constrained. Constraints 313 and 314 of FIG. 3D may ensure content j is accessed from one peer node 301 when it is absent from the CC of intermediate node 300 and the CC of the decision maker node 302. Constraint 315 of FIG. 3C may direct storage allocation at one or more of the nodes in the sub-network 319. Constraint 316 of FIG. 3C may be designed to avoid congestion on the uplink between the peer node 301 and the decision maker node 302. Constraint 317 of FIG. 3D may be designed to avoid congestion on the downlink between the decision maker node 302 and the intermediate node 300. Constraint 318 of FIG. 3D may be designed to avoid congestion on the downlink between the server 303 and the decision maker node 302.

The linear program optimization may be executed by decision maker node 202 to determine storage size allocation at one or more nodes in the sub-network 319 and to determine where to store contents in the sub-network 319 to minimize the total data download cost in the sub-network 319. The linear program optimization may be executed using the Interior Point or Simplex method.

Executing the linear program optimization may indicate a probability of a content in a node in the sub-network 319, e.g., pᵢⱼ the probability of content j in node i. The decision maker node 302 may set one or more cache flags according to the probability of the content in the node determined using the linear program optimization. For example, the decision maker node 302 may set one or more cache flags according to the probability pᵢⱼ of content j in node i in the sub-network 319. If the probability of a content in a node is fractional, the decision maker node 302 may set one or more cache flags to indicate to one or more nodes of the sub-network 319 to cache one or more chunks of data. These and other aspects are discussed in more detail below.

FIG. 4 is a block diagram illustrating an example ICN router system (hereinafter “system 400”), arranged in accordance with at least one implementation described herein. The system 400 may be arranged for content placement along the delivery path of a sub-network of node, in accordance with at least one implementation described herein and may be implemented as a computing device or system.

The system 400 may include or correspond to any one of the request nodes 103, intermediate nodes 102, peer nodes 106, and/or decision maker nodes 101 of FIG. 1. The system 400 may also include or correspond to any one of the intermediate node 300, peer node 301, and/or decision maker node 302 of FIG. 3. For example, one or more of the request nodes 103, intermediate nodes 102, peer nodes 106, decision maker nodes 101, intermediate node 300, peer node 301, and/or decision maker node 302 may be implemented as the system 400. The system 400 may be implemented as a router or routing device or other device capable of routing as described herein.

The system 400 may include a cache manager application 401, a processor device 407, a first interface 410, a second interface 413, a storage 415, and a memory 408 according to some examples. The components of the system 400 may be communicatively coupled by a bus 417. The bus 417 may include, but is not limited to, a memory bus, a storage interface bus, a bus/interface controller, an interface bus, or the like or any combination thereof.

The processor device 407 includes an arithmetic logic unit, a microprocessor, a general-purpose controller, or some other processor array to perform or control performance of operations as described herein. The processor device 407 processes data signals and may include various computing architectures including a complex instruction set computer (CISC) architecture, a reduced instruction set computer (RISC) architecture, or an architecture implementing a combination of instruction sets. Although FIG. 4 includes a single processor device 407, multiple processor devices may be included. Other processors, operating systems, and physical configurations may be possible.

The memory 408 stores instructions and/or data that may be executed and/or operated on by the processor device 407. The instructions or data may include programming code that may be executed by the processor device 407 to perform or control performance of the operations described herein. The instructions or data may include the CC 200, the PIT 201, and/or the FIB 202 of FIG. 2 and/or the access history table 204 and/or the solution table 203 of FIG. 2B. The instructions or data may include the access history table 204 and/or the solution table 203 when the system 400 includes a decision maker node. The memory 408 may include a dynamic random access memory (DRAM) device, a static random access memory (SRAM) device, flash memory, or some other memory device. In some implementations, the memory 408 also includes a non-volatile memory or similar permanent storage and media including a hard disk drive, a floppy disk drive, a CD-ROM device, a DVD-ROM device, a DVD-RAM device, a DVD-RW device, a flash memory device, or some other mass storage for storing information on a more permanent basis.

The first interface 410 is configured to receive interest packets from and send data packets to at least one or more request nodes, intermediate nodes, and/or decision maker nodes, as explained with respect to FIG. 2A. For example, the first interface may be configured to receive interest packets from and send data packets to the request nodes 103, intermediate nodes 102, and/or decision maker nodes 101 of FIG. 1 and/or the intermediate node 300 and/or decision maker node 302 of FIG. 3A.

The second interface 413 is configured to forward interest packets to and receive data packets from at least one intermediate node, peer node, and/or node upstream to a decision maker node, as explained with respect to FIG. 2A. For example, the second interface 413 may be configured to forward interest packets to and receive data packets from the intermediate nodes 102, peer nodes 106 and/or upstream nodes 105 of FIG. 1 and/or intermediate node 300 and/or peer node 301 of FIG. 3A.

In some implementations, the first and second interfaces 410, 413 include a port for direct physical connection to other nodes in the ICN 100 of FIG. 1 and/or the ICN 306 of FIG. 3A or to another communication channel. For example, the first and second interfaces 410, 413 may include a universal serial bus (USB) port, a secure digital (SD) port, a category 5 cable (CAT-5) port, or similar port for wired communication with at least one of the components 101-106 of FIG. 1 and/or at least one of the components 300-303 of FIG. 3A. In some implementations, the first and second interfaces 410, 413 include a wireless transceiver for exchanging data with at least one of the components 101-106 of FIG. 1 and/or 300-303 of FIG. 3A or other communication channels using one or more wireless communication methods, including IEEE 802.11, IEEE 802.16, BLUETOOTH®, or another suitable wireless communication method.

In some implementations, the first and second interfaces 410, 413 include a cellular communications transceiver for sending and receiving data over a cellular communications network including via short messaging service (SMS), multimedia messaging service (MMS), hypertext transfer protocol (HTTP), direct data connection, wireless application protocol (WAP), e-mail, or another suitable type of electronic communication. In some implementations, the first and second interfaces 410, 413 may include a wired port and a wireless transceiver. The first and second interfaces 410, 413 may also provide other connections to the ICN 100 and/or 306 of FIGS. 1 and 3A or components thereof, for distribution of files or media objects using standard network protocols including transmission control protocol/internet protocol (TCP/IP), HTTP, HTTP secure (HTTPS), and simple mail transfer protocol (SMTP), etc.

The storage 415 may include a non-transitory storage medium that stores instructions and/or data for providing the functionality described herein. The storage 415 may include a dynamic random access memory (DRAM) device, a static random access memory (SRAM) device, flash memory, or some other memory devices. In some implementations, the storage 415 also includes a non-volatile memory or similar permanent storage and media including a hard disk drive, a floppy disk drive, a CD-ROM device, a DVD-ROM device, a DVD-RAM device, a DVD-RW device, a flash memory device, or some other mass storage for storing information on a more permanent basis. The storage 415 may also store instructions and/or data that are temporarily stored or loaded into the memory 408.

As illustrated in FIG. 4, the cache manager application 401 may include at least one of: a content cache module 403 (hereinafter “CC module 403”), a pending interest table module 405 (hereinafter “PIT module 405”), a forwarding information base module 402 (hereinafter “FIB module 402”), a decision maker module 404 (hereinafter “DM Module 404”), and a communication module 406, collectively referred to herein as “modules 409.” The cache manager application 401, including the modules 402-406, may generally include software that includes programming code and/or computer-readable instructions executable by the processor device 407 to perform or control performance of the functions and operations described herein. The cache manager application 401, including one or more of the modules 402-406, may receive data from one or more of the components of the system 400 and/or may store the data in one or both of the storage 415 and the memory 408.

The CC module 403 may generally be configured to associate interest packets with corresponding data packets that may be stored at intermediate nodes, peer nodes and/or decision maker nodes, such as the intermediate nodes 102, peer nodes 106 and/or decision maker nodes 101 of FIG. 1, and/or the intermediate node 300 and/or peer nodes 301 of FIG. 3A, as described in more detail herein. In this and other implementations, the CC module 403 may read data from and/or write data to the CC 200.

The PIT module 405 may be configured to record and keep track of each received interest packet that is being served or pending (until the corresponding requested data packet is received) by associating each interest packet with one or more receiving interfaces, as described in more detail herein. In these and other implementations, the PIT module 405 may read data from and/or write data to the PIT 201.

The FIB module 402 may be configured to associate interest packets with one or more corresponding interfaces on which the interest packet is forwarded, as described in more detail herein. The FIB module 412 may read data from and/or write data to the FIB 202.

The DM module 404, which may be present when the system 400 includes a decision maker node, may be configured to execute a linear program optimization to determine, based on the popularity of each content of a sub-network at each node in the sub-network, how to allocate storage size at one or more nodes of the sub-network and where to place each of the contents in the sub-network to minimize the total cost of data download in the sub-network. Based on the solution of the linear program optimization, the DM module 404 may be configured to set one or more cache flags in the data packet of a content to inform one or more nodes in the sub-network to cache the content.

The communication module 406 may be implemented as software including routines for handling communications between the modules 402-405 and other components of the system 400. The communication module 406 sends and receives data, via the interfaces, to and from one or more of the components 102-106 of FIG. 1 and/or 300, 301, 303 of FIG. 3A when the cache manager application 401 is implemented at the decision maker node 101 or 302 of FIG. 1 or 3A. In some implementations, the communication module 406 receives data from one or more of the modules 402-405 and stores the data in one or more of the storage 415 and the memory 408. In some implementations, the communication module 406 retrieves data from the storage 415 or the memory 408 and sends the data to one or more of the modules 402-405.

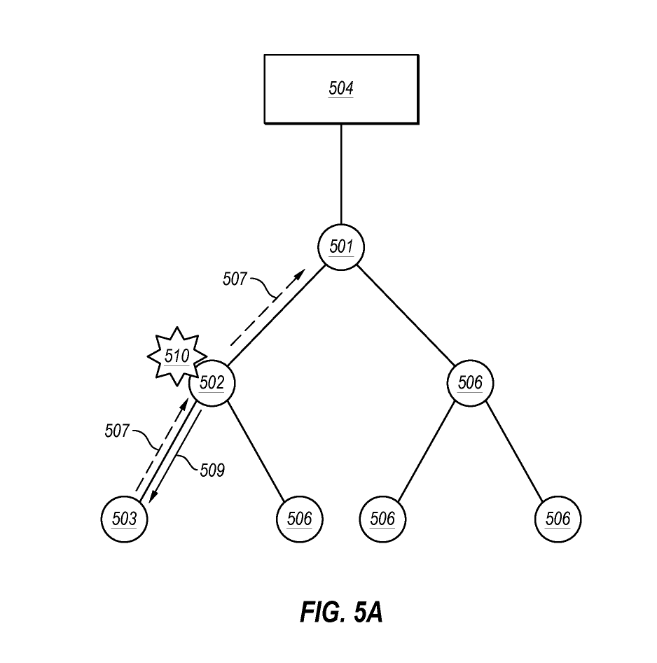

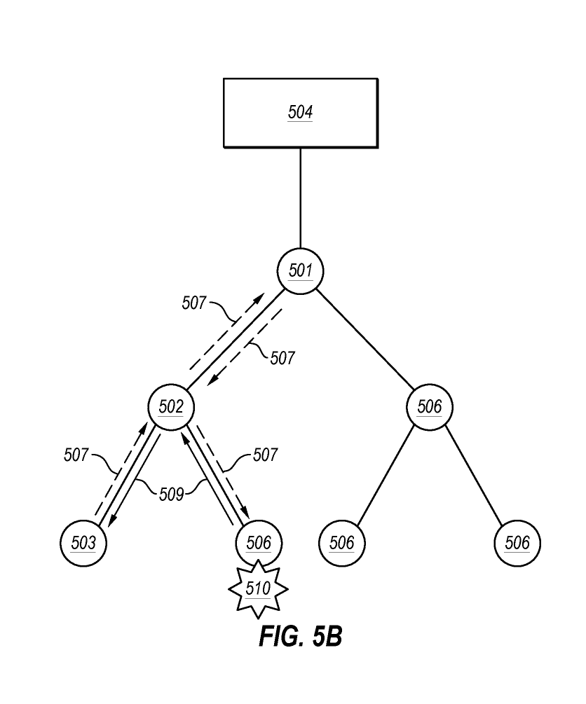

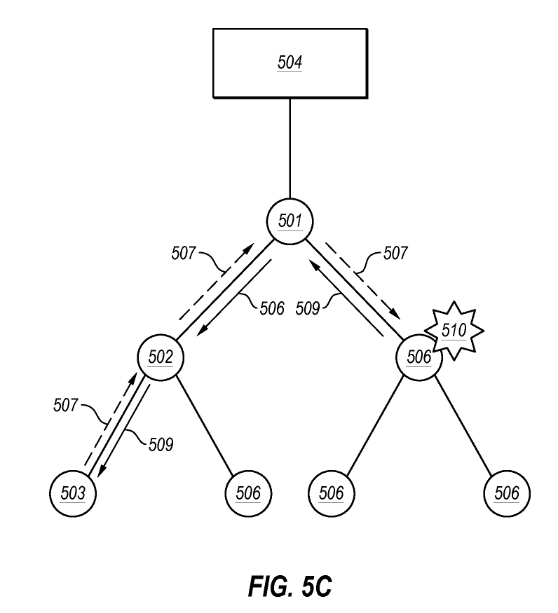

FIGS. 5A-5C are schematic diagrams of example content retrieval scenarios, arranged in accordance with at least one implementation described herein. FIGS. 5A-5C illustrate a sub-network with a tree topology that includes a decision maker node 501, an intermediate node 502, a request node 503, a server 504, and one or more peer nodes 506. The foregoing components may include or correspond to identically-named components in the other Figures. FIGS. 5A-5C additionally depict one or more interest packet(s) 507, data packets 509, and content 510. The content 510 may include the data packets 509. In the discussion of FIGS. 5A-5C, it is assumed that each of the nodes 501-503 and 506 is individually implemented according to the ICN router system 400 of FIG. 4.

In FIG. 5A, the communication module 406 of the intermediate node 502 may receive an interest packet 507 from the request node 503. The interest packet 507 may identify a content name of the content 510 being requested by the request node 503 and may identify the request node 503, as well as any nodes that forward the interest packet to the decision maker node 501. In this and other implementations, the CC module 403 of the intermediate node 502 may check the CC 200 of the intermediate node 502 for the content 510, and in response to the content being stored in the CC 200 of the intermediate node 502, the communication module 406 of the intermediate node 502 may forward the data packet 509 of the content 510 from the intermediate node 502 to the request node 503. The FIB module 402 of the intermediate node 502 may forward the interest packet 507 to the decision maker node 501 with a satisfied flag on to indicate the interest packet 507 has already been satisfied. The DM module 404 of the decision maker node 501 may update the access history table 204 of the decision maker node 501 accordingly.

Alternately, in response to the content 510 being absent from the CC 200 of the intermediate node 502, as illustrated in FIGS. 5B and 5C, the PIT module 405 of the intermediate node 502 may record the interest packet 507 in the PIT 201 of the intermediate node 502; the FIB module 402 of the intermediate node 502 may forward the interest packet 507 to the decision maker node 501 with the satisfied flag turned off in the interest packet 507 to indicate that the interest packet 507 has not yet been satisfied; and the CC module 403 of the decision maker node 501 may check the CC 200 of the decision maker node 501 for the content 510.

In response to the content 510 being present in the CC 200 of the decision maker node 501, the communication module 406 of the decision maker node 501 may forward one or more data packets 509 of the content 510 downstream to the intermediate node 502, which may then forward the one or more data packets 509 to the request node 503. In response to the content 510 being absent from the CC 200 of the decision maker node 501, as illustrated in FIGS. 5B and 5C, the DM module 404 of the decision maker node 501 may determine if the content 510 is stored in one of the peer nodes 506 in the sub-network outside of the path between the request node 503 and the decision maker node 501 by checking the access history table 204 and/or the solution table 203 of the decision maker node 501 obtained from executing the linear program optimization.

In FIGS. 5B and 5C, the content 510 is illustrated as being stored in a different one of the peer nodes 506 in the sub-network outside of the path between the request node 503 and the decision maker node 501. In response to determining that the content 510 is stored in a corresponding one of the peer nodes 506 in the sub-network outside of the path between the request node 506 and the decision maker node 501, the DM module 404 of the decision maker node 501 may select the corresponding one of the peer nodes 506, and the FIB module 402 of the decision maker node 501 may forward the interest packet 507 from the decision maker node 501 to the corresponding peer node 506. In some examples, such as in FIG. 5B, the interest packet 507 may be forwarded from the decision maker node 501 to the corresponding peer node 506 through the intermediate node 502 (or multiple intermediate nodes) and/or other peer nodes 506. In response to determining that the content 510 is stored in a corresponding one of the peer nodes 506 that is separated from the decision maker node 501 by one or more intervening nodes, such the intermediate node 502 (or multiple intermediate nodes) or one or more other peer nodes 506 that do not have the content 510, the DM module 404 of the decision maker node 501 may include, in the interest packet 507, directions to the peer node 506 that has the content 510. The directions may include next hop information.

After the peer node 506 identified as having the content 510 receives the interest packet 507, the CC module 403 of the peer node 506 may check the CC 200 of the peer node 506, and in response to the content being stored in the CC 200 of the peer node 506, the communication module 406 of the peer node 506 may send the one or more data packets 509 of the content 510 from the peer node 506 to the request node 503 through one or more intervening nodes, such as one or more of the peer nodes 506, the decision maker node 501, and the intermediate node 502.

In response to determining that the content 510 is stored in more than one of the peer nodes 506, the DM module 404 of the decision maker node 501 may select the peer node 506 that is the closest to or the fewest hops from the request node 503 or based on the peer probabilities, e.g. qᵢⱼ^{k} of FIGS. 3B-3C, obtained from executing a linear program optimization, and the FIB module 402 of the decision maker node 501 may forward the interest packet 507 to the selected peer node 506. In some instances, and as previously indicated, directions to the peer node 506 may be included in or with the interest packet 507.

In the example of FIG. 5C, the communication module 406 of the peer node 506 that includes the content 510 may send the one or more data packets 509 of the content 510 to the request node 503 via the decision maker node 501.

The DM module 404 of the decision maker node 501 may execute, or may have previously executed, a linear program optimization to determine, based on the popularity of each content of the sub-network at each node 501-503, 506 in the sub-network, how to allocate storage size at one or more nodes 501-503, 506 of the sub-network and where to place each of the contents in the sub-network to minimize the total cost of data download in the sub-network. Based on the solution of the linear program optimization, the DM module 404 of the decision maker node 501 may set one or more cache flags in the data packet 509 to inform one or more nodes 501-503, 506 in the sub-network to store the data packet 509 of the content 510.

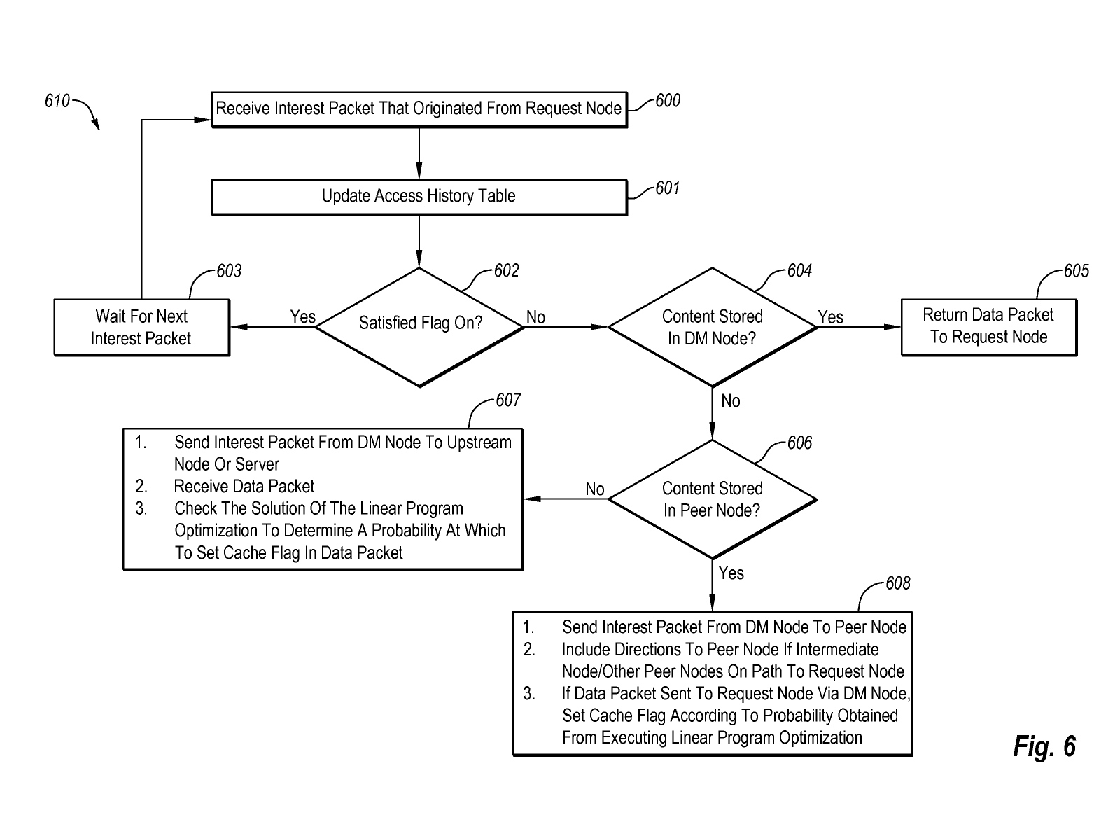

FIG. 6 is an example flow diagram of a method 610 for content placement along a delivery path of a sub-network of nodes in an ICN, arranged in accordance with at least one implementation described herein. The method 610 may be implemented, in whole or in part, by one or more decision maker nodes 101 of FIG. 1, decision maker nodes 302 of FIG. 2, decision maker nodes 501 of FIG. 5, or another suitable network node, ICN router, and/or system. The method 610 may begin at block 600.

In block 600, a decision maker node receives an interest packet that originated from a request node. The decision maker node and the request node may be located in a sub-network of the ICN and may have a tree topology. The interest packet may identify a content and the request node, as well as any nodes that forward the interest packet to the decision maker node. The decision maker node may include the decision maker node 101 of FIG. 1, the decision maker node 302 of FIG. 2, or the decision maker node 501 of FIG. 5. The request node may include the request node 103 of FIG. 1 or the request node 503 of FIG. 5. Block 600 may be followed by block 601.

In block 601, the decision maker node may update its access history table, which may include the access history table 204 of FIGS. 2B and 4. Block 601 may be followed by block 602.

In block 602, the decision maker node may determine if there is a satisfied flag on in the interest packet that originated from the request node. Block 602 may be followed by block 603 if the satisfied flag is on (“Yes” at block 602) or by block 604 if the satisfied flag is off (“No” at block 602). The satisfied flag may be on in response to the content being stored in one or more intermediate nodes on a path between the request node and the decision maker node. The satisfied flag may be off in response to the content being absent from each of the one or more intermediate nodes on the path between the request node and the decision maker node.

In block 603, in response to the satisfied flag being on in the interest packet, the decision maker node will wait to receive the next interest packet and/or the method 610 may return to block 600 from block 603.

In block 604, in response to the satisfied flag being off in the interest packet, the decision maker node may check its CC for the content. Block 604 may be followed by block 605 if the content is stored in the CC of the decision maker node (“Yes” at block 604) or by block 606 if the content is absent from the CC of the decision maker node (“No” at block 604). The CC of the decision maker node may include the CC 200 of FIGS. 2A and 4.

In block 605, in response to the content being present in the CC of the decision maker node, the decision maker node may return the data packet of the content to the request node.

In block 606, in response to the content being absent from the CC of the decision maker node, the decision maker node may determine if the content is stored in a peer node in the sub-network outside of the path between the request node and the decision maker node by checking the access history table and/or the solution table of the decision maker node obtained from executing a linear program optimization. The peer node may include the peer node 106 of FIG. 1, the peer node 301 of FIG. 3A, or the peer node 506 of FIG. 5. The solution table may include the solution table 203 of FIGS. 2B and 4. The access history table may include the access history table 204 of FIGS. 2B and 4. The linear program optimization may include the linear program optimization illustrated in and described with respect to FIGS. 3B-3D. Block 606 may be followed by block 607 (“No” at block 606) or by block 608 (“Yes” at block 606).

In block 607, in response to the decision maker node determining that the content is absent from a peer node of the sub-network, the decision maker node may forward the interest packet to an upstream node or server. The server may include the server 104 of FIG. 1, the server 303 of FIG. 3A, or the server 504 of FIG. 5. The upstream node may include the upstream node 105 of FIG. 1. After the decision maker node receives a corresponding data packet from the upstream node or server, the decision maker node may check the solution of the linear program optimization to determine a probability at which to set each of one or more cache flags in the data packet. The probability may include pᵢⱼ the probability of content j in node i, as illustrated in FIGS. 3B-3D. The linear program optimization may include a parameter based on the popularity of each content of the sub-network at each node in the sub-network, e.g. αᵢⱼ of FIGS. 3B-3C.

In block 608, in response to the decision maker node determining that the content is stored in a peer node of the sub-network, the decision maker node may forward the interest packet from the decision maker node to the peer node. The decision maker node may include, in the interest packet, directions to the peer node that has the content in response to one or more intermediate nodes or one or more peer nodes being located in between the decision maker node and the peer node that has the content, wherein the one or more peer nodes are outside of the path between the request node and the decision maker node. As illustrated in FIG. 5C, in some embodiments, a data packet may be sent from a peer node to a request node via the decision maker node. If the data packet is sent to the request node via the decision maker node, the decision maker node may set a cache flag according to the probability of the requested content in a node determined using the linear program optimization. For example, if pᵢⱼ the probability of content j in node i, is determined to be 1 using the linear program optimization, then the decision maker node may set a cache flag indicating to node i to store content j. If pᵢⱼ the probability of content j in node i, is determined to be 0 using the linear program optimization, then the decision maker node may not set a cache flag, and node i will not store content j.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed implementations.

Implementations described herein may include computer-readable media for carrying or having computer-executable instructions or data structures stored thereon. Such computer-readable media may be any available media that may be accessed by a general purpose or special purpose computer. By way of example, and not limitation, such computer-readable media may include non-transitory computer-readable storage media including RAM, ROM, EEPROM, CD-ROM or other optical disk storage, magnetic disk storage or other magnetic storage devices, or any other storage medium which may be used to carry or store desired program code in the form of computer-executable instructions or data structures and which may be accessed by a general purpose or special purpose computer. Combinations of the above may also be included within the scope of computer-readable media.

Computer-executable instructions include, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” may refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

All examples and conditional language recited herein are intended for pedagogical objects to aid the reader in understanding the invention and the concepts contributed by the inventor to furthering the art, and are to be construed as being without limitation to such specifically recited examples and conditions. Although implementations of the present inventions have been described in detail, it should be understood that the various changes, substitutions, and alterations could be made hereto without departing from the spirit and scope of the invention.

1. A method, comprising:
receiving, at a decision maker node, an interest packet that originated from a request node, wherein the decision maker node and the request node are part of a plurality of nodes of a sub-network with a tree topology and wherein the interest packet identifies a content and the request node;
in response to the content being stored in one or more intermediate nodes of the plurality of nodes of the sub-network, wherein the one or more intermediate nodes are located in a path between the request node and the decision maker node:
receiving the interest packet with a satisfied flag on at the decision maker node; and
updating an access history table at the decision maker node; and
in response to the content being absent from each of the one or more intermediate nodes of the plurality of nodes of the sub-network:
receiving the interest packet with the satisfied flag off at the decision maker node;
updating the access history table at the decision maker node; and
checking the decision maker node for the content.

2. The method of claim 1, further comprising, in response to the content being absent from the one or more intermediate nodes and the decision maker node:
determining that the content is stored in a peer node of the plurality of nodes of the sub-network, wherein the peer node is outside of the path between the request node and the decision maker node; and
forwarding the interest packet from the decision maker node to the peer node.

3. The method of claim 2, further comprising, the decision maker node including, in the interest packet, directions to the peer node that has the content in response to one or more intermediate nodes and/or one or more peer nodes being located in between the decision maker node and the peer node that has the content, wherein the one or more peer nodes are outside of the path between the request node and the decision maker node.

4. The method of claim 2, wherein determining that the content is stored in the peer node includes checking a solution obtained from executing a linear program optimization.

5. The method of claim 4, wherein the linear program optimization includes a parameter based on a popularity of each content of the sub-network at each node of the sub-network, as determined by the access history table, and wherein executing the linear program optimization includes determining a probability at which to set each of one or more cache flags in a data packet of the content.

6. The method of claim 1, further comprising, in response to receipt of a data packet of the content at the decision maker node, setting one or more cache flags in the data packet to indicate to the request node, to at least one of the one or more intermediate nodes, or to both to store the content.

7. The method of claim 6, further comprising, prior to setting the one or more cache flags, executing a linear program optimization to determine a probability at which to set each of the one or more cache flags.

8. The method of claim 7, wherein the linear program optimization includes a parameter based on a popularity of each content of the sub-network at each node of the sub-network, as determined by the access history table.

9. The method of claim 8, wherein executing the linear program optimization includes determining a storage size allocation at one or more nodes of the plurality of nodes of the sub-network.

10. A system, comprising:
a plurality of nodes of a network with a tree topology, the plurality of nodes including a decision maker node, a request node, and one or more intermediate nodes, wherein the decision maker node is configured to:
receive an interest packet that originated from the request node, wherein the interest packet identifies a content and the request node;
in response to the content being stored in the one or more intermediate nodes, wherein the one or more intermediate nodes are located in a path between the request node and the decision maker node:
receive the interest packet with a satisfied flag on; and
update an access history table at the decision maker node; and
in response to the content being absent from each of the one or more intermediate nodes:
receive the interest packet with the satisfied flag off;
update the access history table at the decision maker node; and
check the decision maker node for the content.

11. The system of claim 10, wherein in response to the content being absent from the one or more intermediate nodes and the decision maker node, the decision maker node is further configured to:
determine that the content is stored in a peer node of the plurality of nodes of the sub-network outside of the path between the request node and the decision maker node; and
forward the interest packet from the decision maker node to the peer node.

12. The system of claim 11, wherein the decision maker node is further configured to include, in the interest packet, directions to the peer node that has the content in response to one or more intermediate nodes and/or one or more peer nodes being located between the decision maker node and the peer node that has the content, wherein the one or more peer nodes are outside of the path between the request node and the decision maker node.

13. The system of claim 11, wherein the decision maker node is configured to:
determine that the content is stored in the peer node by being configured to check a solution obtained from executing a linear program optimization that includes a parameter based on a popularity of each content of the sub-network at each node of the sub-network, as determined by the access history table; and
determine a probability at which to set each of one or more cache flags in a data packet of the content.

14. The system of claim 10, wherein the decision maker node is further configured to in response to receipt of a data packet of the content at the decision maker node, set one or more cache flags in the data packet to indicate to the request node, to at least one of the one or more intermediate nodes, or to both to store the content.

15. The system of claim 14, wherein:
the decision maker node is further configured to, prior to setting the one or more cache flags, execute a linear program optimization to determine a probability at which to set each of the one or more cache flags;
the linear program optimization includes a parameter based on a popularity of each content of the sub-network at each node of the sub-network, as determined by the access history table; and
executing the linear program optimization includes determining a storage size allocation at one or more nodes of the plurality of nodes of the sub-network.

16. A non-transitory computer-readable medium that includes computer-readable instructions stored thereon that are executable by a processor to perform or control performance of operations comprising:
receiving, at a decision maker node, an interest packet that originated from a request node, wherein the decision maker node and the request node are part of a plurality of nodes of a sub-network with a tree topology and wherein the interest packet identifies a content and the request node;
in response to the content being stored in one or more intermediate nodes of the plurality of nodes of the sub-network, wherein the one or more intermediate nodes are located in a path between the request node and the decision maker node:
receiving the interest packet with a satisfied flag on at the decision maker node; and
updating an access history table at the decision maker node;
in response to the content being absent from the intermediate nodes of the plurality of nodes of the sub-network:
receiving the interest packet with the satisfied flag off at the decision maker node;
updating the access history table at the decision maker node; and
checking the decision maker node for the content; and
in response to the content being absent from the intermediate nodes and the decision maker node:
determining that the content is stored in a peer node of the plurality of nodes of the sub-network, wherein the peer node is outside of the path between the request node and the decision maker node; and
forwarding the interest packet from the decision maker node to the peer nodes.

17. The non-transitory computer-readable medium of claim 16, wherein:
the operations further comprise including, in the interest packet, directions to the peer node that has the content in response to one or more intermediate nodes or one or more peer nodes being located between the decision maker node and the peer node that has the content; and
the one or more peer nodes are outside of the path between the request node and the decision maker node.

18. The non-transitory computer-readable medium of claim 16, wherein:
determining that the content is stored in the peer node comprises checking a solution obtained from executing a linear program optimization that includes a parameter based on a popularity of each content of the sub-network at each node of the sub-network, as determined by the access history table; and
the operations further comprise determining a probability at which to set each of one or more cache flags in a data packet of the content.

19. The non-transitory computer-readable medium of claim 16, wherein the operations further comprise in response to receipt of a data packet of the content at the decision maker node, setting one or more cache flags in the data packet to indicate to the request node, to at least one of the one or more intermediate nodes, or to both to store the content.

20. The non-transitory computer-readable medium of claim 19, wherein:
the operations further comprise, prior to setting the one or more cache flags, executing a linear program optimization to determine a probability at which to set each of the one or more cache flags;
the linear program optimization includes a parameter based on a popularity of each content of the sub-network at each node of the sub-network, as determined by the access history table; and
executing the linear program optimization includes determining a storage size allocation at one or more nodes of the plurality of nodes of the sub-network.
